(19) United States
(12) Patent Application Publication
(10) Pub. No.: US 2011/0168269 A1
(43) Pub. Date: Jul. 14, 2011

(54) MICROFLUIDIC DEVICE

(75) Inventors: Javob Marinus Jan Den Toonder, Eindhoven (NL); Mirielle Aann Reijmi, Utrecht (NL); Marc Wilhelmus Gijsbert Ponjee, Eindhoven (NL); Murray Fulton Gillies, Eindhoven (NL)

(73) Assignee: KONINKLIJKE PHILIPS ELECTRONICS N.V., EINDHOVEN (NL)

(21) Appl. No.: 13/063,328

(22) PCT Filed: Sep. 9, 2009
(86) PCT No.: PCT/IB2009/053941

§ 371 Date: Mar. 10, 2011

(30) Foreign Application Priority Data
Sep. 17, 2008 (EP) 08164484.1

(51) Int. Cl. F15D 1/00; B01L 3/00; B23P 17/00

(52) U.S. Cl. 137/1; 422/504; 29/890.09

(57) ABSTRACT

The present invention provides a microfluidic device. The microfluidic device comprises a first fluidic compartment (10) and a second fluidic compartment (11). The microfluidic device furthermore comprises at least one micromechanical actuator element (14) for, when in use, forcing a sample fluid to flow from the first fluidic compartment (10) into the second fluidic compartment (11).

### TECHNICAL FIELD OF THE INVENTION

The present invention relates to a micro fluidic device, to a method for forming such a microfluidic device and to a method for controlling flow of a sample fluid from a first fluidic compartment into a second fluidic compartment of such a microfluidic device.

### BACKGROUND OF THE INVENTION

Miniature microfluidic devices for automated (bio)chemical analysis, such as molecular diagnostics, are becoming an important tool for a variety of clinical, forensic and food applications. Such microfluidic devices which may also be referred to as biochips incorporate a variety of laboratory steps in one device and can be used for rapid testing in the central lab or at the point of care; patient bedside, field test or crime scene.

The time that sample fluids are in contact with reagents and/or the time that fluids are present in a reaction chamber at a certain temperature or concentration is crucial for most of the reaction processes such as e.g. DNA amplification, hybridization, immunoassays, SDA, TMA that have to be carry out on the biochip. Besides the control of liquid release at certain times, the flexibility to control liquid release for multiple compartments provides an important option in order to double check the results or to perform additional tests depending on the outcome of the first test results.

A conventional approach to control the release of a liquid from a first compartment into a second compartment is to use a passive valve, i.e. a barrier based on surface tension, to confine a liquid into the first compartment until an overpressure is applied (e.g. with an external pump) which exceeds the pressure barrier of the passive valve. A major drawback of this approach is that the design freedom of the biochip is restricted as all compartments that (temporarily) store liquids will need to be in contact with a pump, which may often be an external pump which requires a fluidic interface between the chip and external instrument. This limits the flexibility and portability of the bio chip.

Recently, electrostatically actuated polymer composite structures (PolyMEMS) have been suggested for use as fluid actuator elements for the manipulation of biological fluids in e.g. channels of biochips. An example of such a structure is schematically illustrated in cross-section in FIG. 1(a). The structure comprises on a substrate 1 an under-electrode 2 covered by a first insulating film 3 such as e.g. a SiO₂ or polyacrylate film, and a second insulating film 4 such as e.g. a polyimide or polyacrylate film. The second film 4 in its turn is covered with a top electrode 5. The second film 4 is structured and freed from the substrate 1 by photolithography and sacrificial layer etching. Upon applying a voltage difference between the two electrodes 2, 5, the second film 4 can overcome the force caused by internal stress and unroll. When the voltage is removed the film 4 rolls up again to its original position. The structures can be between 15 and 100 μm in length, but also larger structures can be realized. FIG. 1(b) shows a micrograph of such a film 4 in the rolled up state. The structures can be actuated at frequencies of between 0 Hz and 200 Hz, even in the presence of a fluid. Such structures can be used to efficiently mix fluids.

An alternative to electrostatic actuation is magnetic field actuation. In this case the structure to be actuated is made from a magnetic material, or comprises magnetic particles, which can be either attracted or repelled from the substrate where coils or current wires, that generate a magnetic field, are situated. A magnetic field may also be induced by a (moving) permanent magnetic. Advantages of magnetic actuation as compared to electrostatic are (i) that depending on the direction of the magnetic field the force can be either repulsive or attractive, (ii) the sample liquid does not comprise significant magnetic material and so is unaffected by the magnetic field, (iii) no electrolysis can occur and (iv) there are no electrodes in the sample liquid, therefore there are no biocompatibility issues.

Yet other alternatives are to use light, changes in the environment (e.g. change of humidity) or heat (e.g. a controlled temperature change) to actuate the polyMEMS.

FIG. 2 illustrates a passive check valve which is suitable to keep the fluid confined in a first compartment 6 at the entrance 7 of a second compartment 8. Often, only capillary forces are used to let the fluidic sample flow into the first compartment 6 until the entrance 7 of the second compartment 8. When a slight pressure difference is applied to overcome the pressure barrier of the valve, e.g. by using an external pump, the liquid flows from the first compartment 6 into the second compartment 8.

Another method for creating a passive valve is by applying a hydrophobic (e.g. in the case of an aqueous liquid) or hydrophilic region (e.g. in the case of an oil like liquid) in between the two compartments 6, 8. Similarly, as in the case of the passive check valve described above, when a slight pressure difference is applied to overcome the pressure barrier of the valve, e.g. by using an external pump, the liquid flows from the first compartment 6 into the second compartment 8.

However, the above described valves require the use of an external pump for moving the fluid sample from one compartment into another. This may increase complexity of the microfluidic device or biochip.

### SUMMARY OF THE INVENTION

It is an object of the present invention to provide a microfluidic device, a method for forming such a micro fluidic device and a method for controlling flow of a sample fluid from a first fluidic compartment into a second fluidic compartment of such a microfluidic device.

Embodiments of the present invention provide freedom in the design of the microfluidic device as the entrances of reaction chambers, also referred to as fluidic compartments, in which liquid must be stored, do not need to be connected to an external pump and a valve to select the reaction chamber that must be filled and to control flow of the sample fluid from one fluidic compartment to another fluidic compartment.

Furthermore, because no external pump and valve are required, flexibility, simplicity and portability of the microfluidic device may be improved.

The above objective is accomplished by a method and device according to the present invention.

Particular and preferred aspects of the invention are set out in the accompanying independent and dependent claims. Features from the dependent claims may be combined with features of the independent claims and with features of other dependent claims as appropriate and not merely as explicitly set out in the claims.

The present invention provides a microfluidic device comprising:

a first fluidic compartment,

a second fluidic compartment, and

at least one micromechanical actuator element for, when in use, allowing or forcing a sample fluid to flow from the first fluidic compartment into the second fluidic compartment (11). The at least one micromechanical actuator element can be located in the first fluidic compartment and/or in the second fluidic compartment.

Actuation of the micromechanical actuator element preferably causes: a distortion or breaking, of the fluid meniscus, and/or

lowering of the surface tension, e.g. by creating a hydrophobic/hydrophilic path across the barrier, and/or

creation of fluid displacement across the barrier by enforcing a flow.

Preferably the at least one micromechanical actuator element is coated with a surfactant. This has the advantage of lowering the surface energy of the surface of the actuator element.

In one embodiment the microfluidic device comprises a plurality of micromechanical actuator elements, the plurality of micromechanical actuator elements being grouped in at least one block of plurality of micromechanical actuator elements. Such a plurality of microfluidic elements in a block can be arranged in an array.

In another embodiment the micro fluidic device furthermore comprises means for determining when the sample fluid flows into the second fluidic compartment, e.g. a fluid flow detector, a fluid presence detector or a fluid level detector. For example, the means for determining when the sample fluid flows into the second fluidic compartment can comprise an electrode in electrical connection with the at least one micromechanical actuator element.

According to embodiments of the invention, the electrode may be located in the first fluidic compartment. According to other embodiments of the invention, the electrode may be located in the second fluidic compartment.

In a further embodiment the micro fluidic device furthermore comprises a non-wetting area in between the first fluidic compartment and the second fluidic compartment.

In further embodiments the first fluidic compartment can be a capillary fluidic compartment and/or the second fluid compartment can be a reaction chamber of the microfluidic device.

Optionally the at least one micromechanical actuator element can be a polyMEMS.

In a further aspect the present invention provides a method for manufacturing a microfluidic device, the method comprising:

providing a first fluidic compartment,

providing a second fluidic compartment, and

providing at least one micromechanical actuator element for, when in use, forcing a sample fluid to flow from the first fluidic compartment into the second fluidic compartment.

Preferably actuation of the micromechanical actuator element causes: a distortion or breaking, of the fluid meniscus, and/or

lowering of the surface tension, e.g. by creating a hydrophobic/hydrophilic path across the barrier, and/or

creation of fluid displacement across the barrier by enforcing a flow.

The at least one micromechanical actuator element cane be provided in the first fluidic compartment and/or in the second fluidic compartment.

The method may furthermore comprise providing means for determining when the sample fluid flows into the second fluidic compartment, e.g. a fluid flow detector, a fluid presence detector or a fluid level detector. For example, the means for determining when the sample fluid flows into the second fluidic compartment can comprise an electrode in electrical contact with the at least one micromechanical actuator element.

In an embodiment the method may furthermore comprise providing a non-wetting area in between the first fluidic compartment and the second fluidic compartment.

In a further embodiment the method may furthermore comprise coating the at least one micromechanical actuator element with a surfactant.

The present invention also provides a method for controlling flow of a sample fluid from a first fluid compartment to a second fluid compartment of a micro fluidic device, the method comprising:

applying a sample fluid to the first fluidic compartment, and

actuating at least one micromechanical actuator element for allowing the sample fluid to flow from the first fluidic compartment to the second fluid compartment.

Preferably actuation of the micromechanical actuator element causes: a distortion or breaking, of the fluid meniscus, and/or

lowering of the surface tension, e.g. by creating a hydrophobic/hydrophilic path across the barrier, and/or

creation of fluid displacement across the barrier by enforcing a flow.

In some embodiments actuating the at least one micromechanical actuator element is performed electrically, optically, magnetically or by heating.

The method may also include use of means for determining when the sample fluid) flows into the second fluidic compartment, e.g. a fluid flow detector, a fluid presence detector or a fluid level detector. For example, the means for determining when the sample fluid flows into the second fluidic compartment comprises an electrode in electrical connection with the at least one micromechanical actuator element.

The present invention also provides a controller for controlling flow of a sample fluid from a first fluidic compartment to a second fluid compartment of a microfluidic device, the controller comprising a control unit for controlling actuation means for actuating at least one micromechanical actuator element of the microfluidic device.

A computer program product is also provided for performing, when executed on a computing means, any of the methods of the present invention.

The present invention also provides a machine readable data storage device storing the computer program product according to embodiments of the present invention.

The present invention also provides transmission of the computer program products according to embodiments of the present invention over a local or wide area telecommunications network.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1 illustrates a polyMEMS structure according to the prior art (a) and a SEM image of such a structure (b).

FIG. 2 illustrates a passive check valve according to the prior art (a) and its principle of functioning (b).

FIG. 3 to FIG. 7 illustrate microfluidic devices according to different embodiments of the present invention.

FIG. 8 schematically illustrates a system controller for use with a microfluidic device according to embodiments of the present invention.

FIG. 9 is a schematic representation of a processing system as can be used for performing a method for controlling a fluid flow from a first fluidic compartment into a second fluid compartment of a microfluidic device according to embodiments of the present invention.

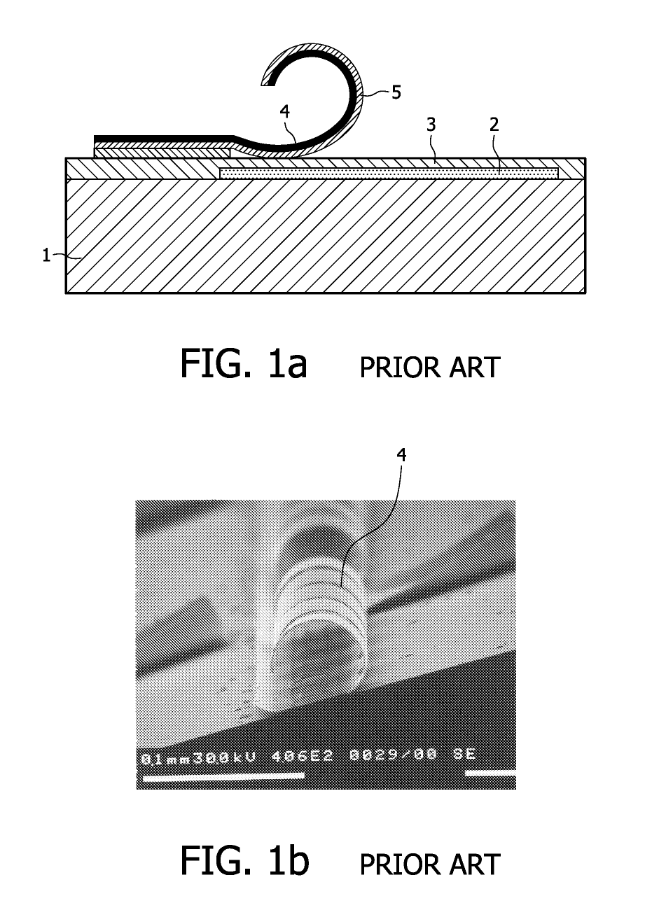

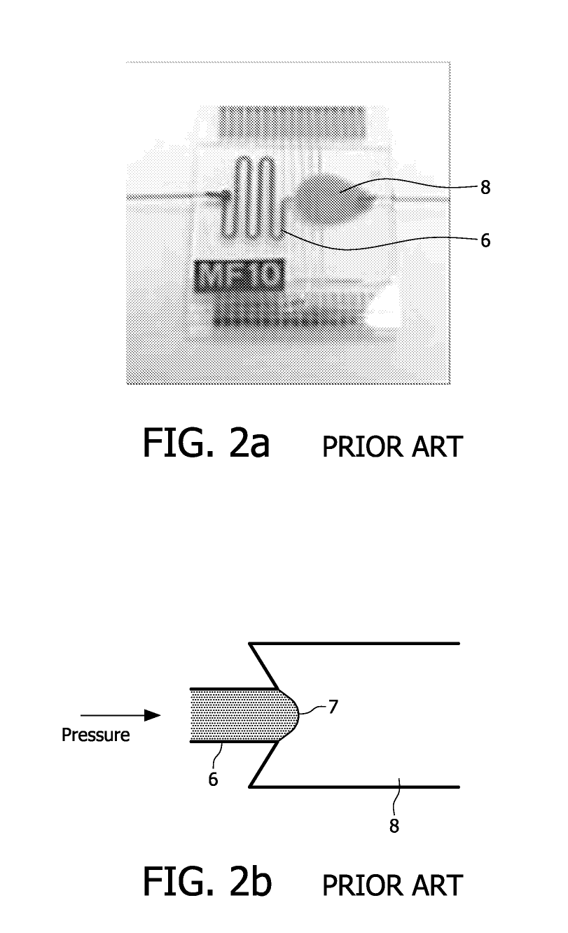

In the different figures, the same reference signs refer to the same or analogous elements.

### DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

The invention will now be described by a detailed description of several embodiments of the invention. It is clear that other embodiments of the invention can be configured according to the knowledge of persons skilled in the art without departing from the true spirit or technical teaching of the invention, the invention being limited only by the terms of the appended claims.

The present invention provides a microfluidic device, a method for forming such a microfluidic device and a method for controlling flow of a sample fluid from a first fluidic compartment into a second fluidic compartment of such a microfluidic device.

Embodiments of the present invention propose the use of at least one micromechanical actuator element to overcome a pressure barrier caused by the presence of a (passive) valve formed by a fluid meniscus between two neighboring fluidic compartments. Overcoming this pressure barrier is necessary to control the flow of a fluid sample from a first compartment into a second compartment.

In a first aspect, the present invention provides a microfluidic device or biochip comprising:

a first fluidic compartment,

a second fluidic compartment, and

at least one micromechanical actuator element for, when in use, forcing a sample fluid to flow from the first fluidic compartment into the second fluidic compartment.

Embodiments of the present invention provide freedom in the design of the microfluidic device as the entrances of reaction chambers, also referred to as fluidic compartments, in which liquid must be stored, do not need to be connected to an external pump and a valve to select the reaction chamber that must be filled and to control flow of the sample fluid from one fluidic compartment to another fluidic compartment.

Furthermore, because no external pump and valve are required, flexibility, simplicity and portability of the microfluidic device may be improved.

In order to overcome the pressure barrier caused by the presence of the (passive) valve formed by the fluid meniscus between the first fluidic compartment and the second fluidic compartment, the at least one micromechanical actuator element is placed near the fluid meniscus, in such a way that actuation of the micromechanical actuator element causes:

(i) a distortion, e.g. breaking, of the fluid meniscus, and/or
(ii) lowering of the surface tension, e.g. by creating a hydrophobic/hydrophilic path across the barrier, and/or
(iii) creation of fluid displacement across the barrier by enforcing a flow.

According to embodiments of the invention, the at least one micromechanical actuator element may be controlled using electrical fields, magnetic fields, electromagnetic radiation or thermal control. The means for application of these actuation fields can be incorporated in the biochip or in a cartridge in which the biochip is placed to measure and read out the results.

A microfluidic device according to embodiments of the invention comprises at least one integrated micromechanical actuator element, also called integrated actuator element. The actuator element may be, for example, in any of the embodiments of the present invention unimorphs or bimorphs or multimorphs. According to the invention, the integrated micromechanical actuator element may preferably be based on polymer materials. Suitable materials may be found in the book “Electroactive Polymer (EAP) Actuators as Artificial Muscles”, ed. Bar-Cohen, SPIE Press, 2004. However, also other materials may be used for the micromechanical actuator element. The materials that may be used to form micromechanical actuator element according to embodiments of the present invention should be such that the formed micromechanical actuator elements have the following characteristics:

the micromechanical actuator element should be compliant, i.e. not stiff,

the micromechanical actuator element should be tough, not brittle,

the micromechanical actuator element should respond to a certain stimulus such as e.g. light, an electric field, a magnetic field, etc. by bending or changing shape, and

the micromechanical actuator element should be easy to process by means of relatively cheap processes.

Depending on the type of actuation stimulus, the material that is used to form the micromechanical actuator elements may have to be functionalized. Considering the first, second and fourth characteristic of the above summarized list, polymers are preferred for at least a part of the actuators. Most types of polymers can be used according to the present invention, except for very brittle polymers such as e.g. polystyrene which are not very suitable to use with the present invention. In some cases, for example in case of electrostatic or magnetic actuation (see further), metals may be used to form the micromechanical actuator elements or may be part of the actuator elements, e.g. in Ionomeric Polymer-Metal composites (IPMC). For example, for magnetic actuation, FeNi or another magnetic material may be used to form the actuator elements. A disadvantage of metals, however, could be mechanical fatigue and cost of processing. A magnetic material may also be obtained by a composite material, for example a polymer matrix that contain magnetic particles. The particles may be paramagnetic (e.g. ferrite nanoparticles) or ferromagnetic (e.g. iron, cobalt, or cobalt ferrites).

According to embodiments of the invention, all suitable materials, i.e. materials that are able to change shape by, for example, mechanically deforming as a response to an external stimulus, may be used. Traditional materials that show this mechanical response, and that may be applied to form actuator elements for use in the device and methods according to embodiments of the present invention, may be electro-active piezoelectric ceramics such as, for example, barium titanate, quartz or lead zirconate titanate (PZT). These materials may respond to an applied external stimulus, such as for example an applied electric field, by expanding. However, an important drawback of electro-active ceramics is that they are brittle, i.e. they fracture quite easily. Furthermore, the processing technologies for electro-active ceramics are rather expensive and cannot be scaled up to large surface areas. Therefore, electro-active piezoelectric ceramics may only be suitable in a limited number of cases.

A more recently explored class of responsive materials is that of shape memory alloys (SMA's). These are metals that demonstrate the ability to return to a memorized shape or size when they are heated above a certain temperature. The stimulus here is thus change in temperature. Generally, those metals can be deformed at low temperature and will return to their original shape upon exposure to a high temperature, by virtue of a phase transformation that happens at a critical temperature. Examples of such SMA's may be NiTi or copper-aluminum-based alloys (e.g. CuZnAl and CuAl). Also SMA's have some drawbacks and thus limitations in the number of cases in which these materials may be used to form actuator elements. The alloys are relatively expensive to manufacture and machine, and large surface area processing is not easy to do. Also, most SMA's have poor fatigue properties, which means that after a limited number of loading cycles, the material may fail.

Other materials that can be used include all forms of Electroactive Polymers (EAPs). The may be classified very generally into two classes: ionic and electronic. Electronically activated EAPs include any of electrostrictive (e.g. electrostrictive graft elastomers), electrostatic (dielectric), piezoelectric, magnetic, electrovisco-elastic, liquid crystal elastomer, and ferroelectric actuated polymers. Ionic EAPs include gels such as ionic polymer gels, Ionomeric Polymer-Metal Composites (IPMC), conductive polymers and carbon nanotubes. The materials may exhibit conductive or photonic properties, or be chemically activated, i.e. be non-electrically deformable.

Because of the above, according to embodiments of the present invention, the micromechanical actuator elements may preferably be formed of, or include as a part of their construction, polymer materials. Therefore, in the further description, the invention will be described by means of polymer actuator elements or polyMEMS. It has, however, to be understood by a person skilled in the art that the present invention may also be applied when other materials than polymers, as described above, are used to form the actuator elements. Polymer materials are, generally, tough instead of brittle, relatively cheap, elastic up to large strains (up to 10%) and offer perspective of being processable on large surface areas with simple processes.

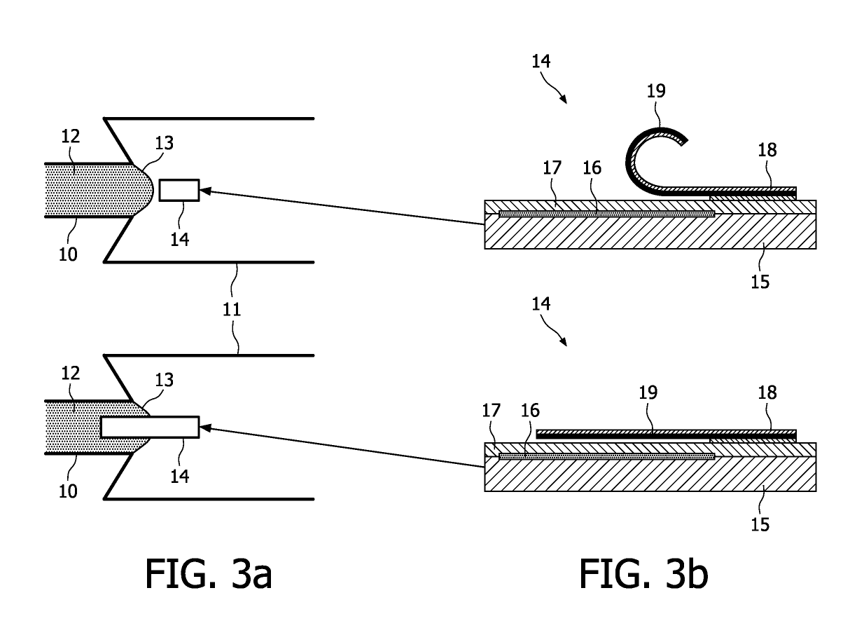

FIG. 3 illustrates a first embodiment of part of a microfluidic device of the present invention. The device comprises a first fluidic compartment 10 and a second fluidic compartment 11. In the present embodiment, the first fluidic compartment 10 is a capillary fluidic compartment. The second fluidic compartment 11 may be a reaction chamber or measurement chamber. A sample fluid 12 is provided in the first, capillary compartment 10. Driven by capillary forces, the sample fluid 12 flows through the first compartment 10 to be provided to the second fluidic compartment 11. At the end of the first, capillary compartment 10, or in other words at the entrance of the second fluidic compartment 11, a fluid meniscus 13 is formed (see FIG. 3(a)), which prevents the sample fluid 12 to flow into the second fluidic compartment 11. Therefore, some kind of force is required for somehow destroying the fluid meniscus 13 and for allowing the sample fluid 12 to flow into the second fluidic compartment 11. According to embodiments of the invention, the microfluidic device therefore comprises at least one micromechanical actuator element 14 (see FIG. 3(b)). According to the present embodiment, the micromechanical actuator element 14 may a polyMEMS actuator which is placed near the meniscus 13. In the example given, the micromechanical actuator element 14 may be located in the second fluidic compartment 11. According to other embodiments of the invention, however, the micromechanical actuator element 14 may also be located in the first fluidic compartment 10 (see further).

The micromechanical actuator element 14 comprises a substrate 15. On the substrate 15 a lower electrode 16 is formed on which a first insulating film 17 is provided. The structure furthermore comprises a second insulating film 18 which is covered by an upper electrode 19. When the device is not functioning, or in other words, when no sample fluid 12 is present, the micromechanical actuator element 14 is in a curled shape, as is illustrated in the upper drawing of FIG. 3. By actuating the micromechanical actuator element 14 it is stretched or unrolled, thereby breaking the fluid meniscus 13. The created distortion of the fluid meniscus 13 initiates a flow of the sample fluid 12 from the first compartment 10 into the second compartment 11. According to embodiments of the invention, actuation of the micromechanical actuator element 14 can be performed in different ways, such as e.g. electrically, optically, magnetically or by heating.

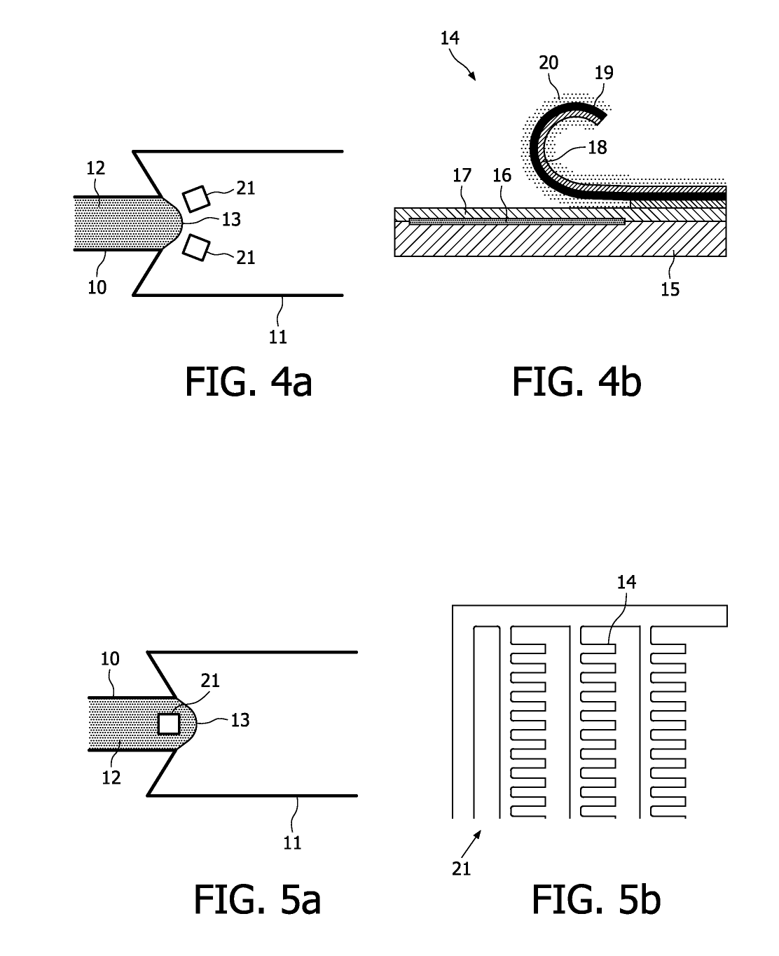

A second embodiment of a microfluidic device according to the invention is illustrated in FIG. 4. According to the second embodiment, the second insulating film 18 of the micromechanical actuator element 14 (see FIG. 4(b)) is coated with a surfactant 20 to lower the surface energy near the fluid meniscus 13. According to the present embodiment, the micro fluidic device may comprise a plurality of micromechanical actuator elements 14 which are located near the fluid meniscus 13. This is illustrated in FIG. 4(a) in which the blocks 21 represent groups of micromechanical actuator elements 14. Within a block 21 of micromechanical actuator elements 14, the actuators 14 may be arranged in an array (see further). When the device is not functioning, or in other words, when no sample fluid 12 is present, the micromechanical actuator element 14 is in a curled shape, as is illustrated in FIG. 4(b). The surfactant 20 is brought into contact with the fluid meniscus 13 by actuating the micromechanical actuator element 14 so that it is unrolled. According to embodiments of the invention, actuation of the micromechanical actuator element 14 can be performed in different ways, such as e.g. electrically, optically, magnetically or by heating. Depending on the sample fluid 12 the microfluidic device is supposed to work for, the surfactant 20 may be different, e.g. may be polar or apolar. Because of the low surface energy of the micromechanical actuator element 14 because of the presence of the surfactant 20 in the neighborhood of the fluid meniscus 13, the sample fluid 12 may start flowing from the first compartment 10 to the second compartment 11. According to the second embodiment, the micromechanical actuator elements 14 may be built up as discussed for the first embodiment.

FIG. 5 illustrates a third embodiment of the microfluidic device according to the present invention. In this third embodiment, a plurality of micromechanical actuator elements 14 are located in the neck of the check valve and thus in the first fluidic compartment 10. This is illustrated in FIG. 5(a) in which the block 21 represents a group of micromechanical actuator elements 14. Within such a block 21, the micromechanical actuator elements 14 may be arranged in an array (see FIG. 5(b) which shows unrolled micromechanical actuator elements 14). According to the third embodiment, the micromechanical actuator elements 14 may be built up as discussed for the first embodiment.

The micromechanical actuator elements 14 are actuated, i.e. opened (stretched) and closed (curled) in the direction of the entrance to the second fluidic compartment 11 to create fluid displacement. When the pressure built up by this generated fluid displacement is large enough the meniscus will break and the sample fluid 12 is allowed to flow from the first fluidic compartment 10 into the second fluidic compartment 11. According to embodiments of the invention, actuation of the micromechanical actuator element 14 can be performed in different ways, such as e.g. electrically, optically, magnetically or by heating.

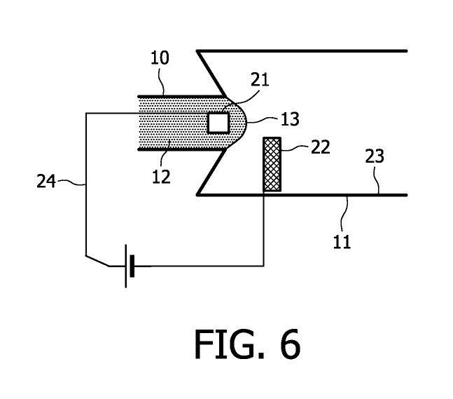

In a fourth embodiment, the microfluidic device may furthermore comprise means for determining when the sample fluid 12 flows into the second fluidic compartment 11. The means for determining when the sample fluid 12 flows into the second fluidic compartment 11 may comprise an electrode 22 which is located in the second fluidic compartment 11, e.g. at an inner wall 23 of the second fluidic compartment 11. According to the present embodiment, a plurality of micromechanical actuator elements 14 is located in the neck of the check valve, and thus in the first fluidic compartment 10. This is illustrated in FIG. 6 in which block 21 represents a group of micromechanical actuator elements 14. As can be seen from FIG. 6, the electrode 22 is located at a different side of the fluid meniscus 13, also referred to as fluid barrier, than the plurality of micromechanical actuator elements 14. The plurality of micromechanical actuator elements 14 is electrically coupled to the electrode 22 through connection 24. Similarly as described in the former embodiment, by actuating the micromechanical actuator elements 14, i.e. by opening (stretching) and closing (curling) in the direction of the entrance to the second fluidic compartment 11, fluid displacement is created. When the pressure built up by this generated fluid displacement is large enough the fluid meniscus 13 will break and the sample fluid 12 is allowed to flow from the first fluidic compartment 10 into the second fluidic compartment 11. According to embodiments of the invention, actuation of the micromechanical actuator elements 14 can be performed in different ways, such as e.g. electrically, optically, magnetically or by heating. According to the fourth embodiment, the micromechanical actuator elements 14 may be built up as discussed above for the first, second, and third embodiment. When the displacement of sample fluid 12 from the first fluidic compartment 10 to the second fluidic compartment 11 takes place the electronic circuit will be closed due to ions in the sample fluid 12, and a current may then be detected. In that way, a fluid displacement sensor is formed.

Alternatively, instead of providing an electrode 22 in the second fluidic compartment 11 as illustrated in FIG. 6, electrode 22 may be provided in the sample fluid 12 and a plurality of micromechanical actuator elements 14 in the second fluidic compartment 11 (not shown in the figures). In that case, the plurality of micromechanical actuator elements 14 are located in the compartment 11 with no sample fluid 12 and monitoring a capacitance between the electrode present in the sample fluid 12 and the common electrode allows the state of the actuator elements 14 to be measured and/or the presence of sample fluid 12 on the actuator elements 14 to be determined.

According to the fourth embodiment, the micromechanical actuator elements 14 may be built up as discussed for the first embodiment.

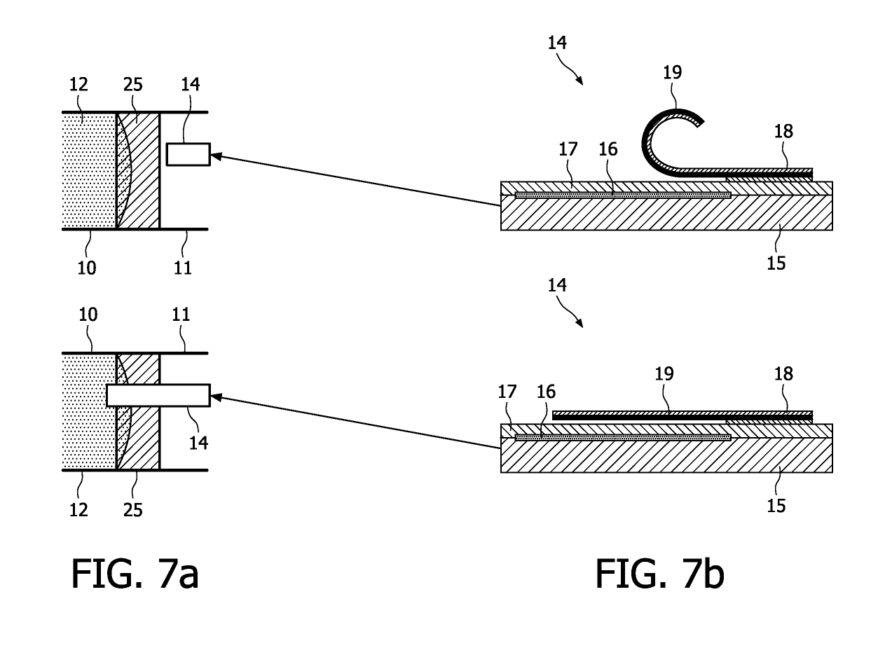

According to a fifth embodiment of the first aspect of the invention which is illustrated in FIG. 7, instead of using micromechanical actuator elements 14 in the neighborhood of a check valve, the principle of the present invention can also be applied in combination with a non-wetting area 25 which acts as a fluidic stop. In that case, the fluid compartment before the non-wetting area 25 is referred to as first fluidic compartment 10 and the fluid compartment after the non-wetting area 25 is referred to as second fluidic compartment 11. The non-wetting area 25 can be created in different ways, e.g. by printing, self assembly or by using mask steps. Depending on the nature of the sample fluid 12, the non-wetting area 25 can be made hydrophobic or hydrophilic. According to this fifth embodiment, the purpose of the presence of the micromechanical actuator elements 14 is not to destroy a fluid meniscus 13. Instead, the actuator, when rolled out, forms a bridge over the non-wetting area 25 between the first fluidic compartment 10 and the second fluidic compartment 11. The microactuator material should therefore be wetting, i.e. its surface energy should be similar to that of the surfaces of the compartments 10 and 11. According to embodiments of the invention, actuation of the micromechanical actuator elements 14 can be performed in different ways, such as e.g. electrically, optically, magnetically or by heating.

According to the fifth embodiment, the micromechanical actuator elements 14 may be built up as discussed for the first embodiment.

In a second aspect the present invention provides a method for manufacturing a microfluidic device. The method comprises:

providing a first fluidic compartment 10,

providing a second fluidic compartment 11, and

providing at least one micromechanical actuator element 14 for, when in use, forcing a sample fluid 12 to flow from the first fluidic compartment 10 into the second fluidic compartment 11.

According to embodiments of the invention, the at least one micromechanical actuator element 14 may be provided in the first fluidic compartment. According to other embodiments of the invention, the at least one micromechanical actuator element 14 may be provided in the first fluidic compartment 11. According to embodiments of the invention, the at least one micromechanical actuator element 14 may be coated with a surfactant to lower the surface energy near the fluid meniscus 13.

The method may furthermore comprise providing means for determining when the sample fluid flows from the first fluidic compartment 10 into the second fluidic compartment 11. According to embodiments of the invention, the means for determining when the sample fluid flows from the first fluidic compartment 10 into the second fluidic compartment 11 may comprise an electrode 22 in electrical contact with the at least one micromechanical actuator element 14.

According to embodiments of the invention, the method may furthermore comprise providing a non-wetting area 25 in between the first fluidic compartment 10 and the second fluidic compartment 11.

In a further aspect the present invention provides a method for controlling flow of a sample fluid 12 from a first fluidic compartment 10 to a second fluid compartment 11 of a micro fluidic device. The method comprises:

applying a sample fluid 12 to the first fluidic compartment 10, and

actuating at least one micromechanical actuator element 14 for allowing the sample fluid 12 to flow from the first fluidic compartment 10 to the second fluid compartment 11.

According to embodiments of the invention, actuating the at least one micromechanical actuator element 14 may be performed electrically, optically, magnetically or by heating.

The method may furthermore comprise determining when the sample fluid 12 flows into the second fluidic compartment 11. This may be done by means of an electrode 22 which may, according to one embodiment, be located at an inner wall 23 of the second fluidic compartment 11. The electrode 22 is in electrical connection with at least one micromechanical actuator element 14 present in the first fluidic compartment 10. According to other embodiments, the electrode 22 may be present in the first fluidic compartment 10, while the at least one micromechanical actuator element 14 is present in the second fluidic compartment 11.

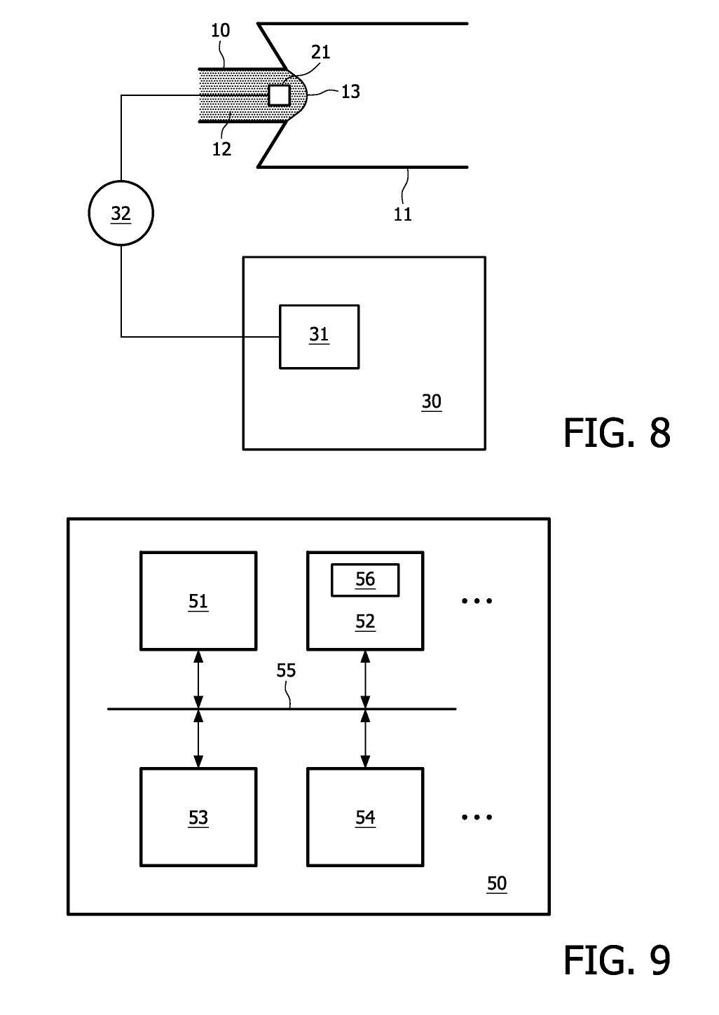

In a further aspect, the present invention also provides a system controller 30 for use in a microfluidic system for controlling flow of a sample fluid 12 from a first fluidic compartment 10 to a second fluid compartment 11 of a microfluidic device according to embodiments of the present invention. The system controller 30, which is schematically illustrated in FIG. 8, may control the overall operation of the microfluidic device for controlling a fluid flow from one compartment to another of the microfluidic system. The system controller 30 according to the present aspect may comprise a control unit 31 for controlling actuation means 32 for actuating at least one micromechanical actuator element 14 of the microfluidic device. The actuation means 32 may be electrical actuation means, optical actuation means, magnetic actuation means or heating means. It is clear for a person skilled in the art that the system controller 30 may comprise other control units for controlling other parts of the micro fluidic system; however, such other control units are not illustrated in FIG. 8.

The system controller 30 may include a computing device, e.g. microprocessor, for instance it may be a micro-controller. In particular, it may include a programmable controller, for instance a programmable digital logic device such as a Programmable Array Logic (PAL), a Programmable Logic Array, a Programmable Gate Array, especially a Field Programmable Gate Array (FPGA). The use of an FPGA allows subsequent programming of the microfluidic device, e.g. by downloading the required settings of the FPGA. The system controller 30 may be operated in accordance with settable parameters.

The method for controlling flow of a sample fluid 12 from a first fluidic compartment 10 to a second fluid compartment 11 of a microfluidic device according to embodiments of the present invention may be implemented in a processing system 50 such as shown in FIG. 9. FIG. 9 shows one configuration of processing system 50 that includes at least one programmable processor 51 coupled to a memory subsystem 52 that includes at least one form of memory, e.g., RAM, ROM, and so forth. It is to be noted that the processor 51 or processors may be a general purpose, or a special purpose processor, and may be for inclusion in a device, e.g., a chip that has other components that perform other functions. Thus, one or more aspects of the present invention can be implemented in digital electronic circuitry, or in computer hardware, firmware, software, or in combinations of them. The processing system may include a storage subsystem 53 that has at least one disk drive and/or CD-ROM drive and/or DVD drive. In some implementations, a display system, a keyboard, and a pointing device may be included as part of a user interface subsystem 54 to provide for a user to manually input information. Ports for inputting and outputting data, e.g. desired or obtained flow rate, also may be included. More elements such as network connections, interfaces to various devices, and so forth, may be included, but are not illustrated in FIG. 9. The various elements of the processing system 50 may be coupled in various ways, including via a bus subsystem 55 shown in FIG. 9 for simplicity as a single bus, but will be understood to those in the art to include a system of at least one bus. The memory of the memory subsystem 52 may at some time hold part or all (in either case shown as 56) of a set of instructions that when executed on the processing system 50 implement the steps of the method embodiments described herein. Thus, while a processing system 50 such as shown in FIG. 9 is prior art, a system that includes the instructions to implement aspects of the methods controlling flow of a sample fluid 12 from a first fluidic compartment 10 to a second fluid compartment 11 of a micro fluidic device is not prior art, and therefore FIG. 9 is not labeled as prior art.

The present invention also includes a computer program product which provides the functionality of any of the methods according to the present invention when executed on a computing device. Such computer program product can be tangibly embodied in a carrier medium carrying machine-readable code for execution by a programmable processor. The present invention thus relates to a carrier medium carrying a computer program product that, when executed on computing means, provides instructions for executing any of the methods as described above. The term “carrier medium” refers to any medium that participates in providing instructions to a processor for execution. Such a medium may take many forms, including but not limited to, non-volatile media, and transmission media. Non volatile media includes, for example, optical or magnetic disks, such as a storage device which is part of mass storage. Common forms of computer readable media include, a CD-ROM, a DVD, a flexible disk or floppy disk, a tape, a memory chip or cartridge or any other medium from which a computer can read. Various forms of computer readable media may be involved in carrying one or more sequences of one or more instructions to a processor for execution. The computer program product can also be transmitted via a carrier wave in a network, such as a LAN, a WAN or the Internet. Transmission media can take the form of acoustic or light waves, such as those generated during radio wave and infrared data communications. Transmission media include coaxial cables, copper wire and fiber optics, including the wires that comprise a bus within a computer.

It is to be understood that although preferred embodiments, specific constructions and configurations, as well as materials, have been discussed herein for devices according to the present invention, various changes or modifications in form and detail may be made without departing from the scope and spirit of this invention.

1. A microfluidic device comprising:
a first fluidic compartment (10),
a second fluidic compartment (11), and
at least one micromechanical actuator element (14) for, when in use, allowing a sample fluid to flow from the first fluidic compartment (10) into the second fluidic compartment (11), actuation of the micromechanical actuator element causing:
a distortion or breaking, of the fluid meniscus, and/or
lowering of the surface tension, e.g. by creating a hydrophobic/hydrophilic path across the barrier, and/or
creation of fluid displacement across the barrier by enforcing a flow.

2. A microfluidic device according to claim 1, wherein the at least one micromechanical actuator element (14) is located in the first fluidic compartment (10).

3. A microfluidic device according to claim 1, wherein the at least one micromechanical actuator element (14) is located in the second fluidic compartment (11).

4. A microfluidic device according to claim 1, wherein the at least one micromechanical actuator element (14) is coated with a surfactant.

5. A microfluidic device according to claim 1, wherein the microfluidic device comprises a plurality of micromechanical actuator elements (14), the plurality of micromechanical actuator elements (14) being grouped in at least one block (21) of plurality of micromechanical actuator elements (14).

6. A microfluidic device according to claim 1, wherein the microfluidic device furthermore comprises means for determining when the sample fluid (12) flows into the second fluidic compartment (11).

7. A microfluidic device according to claim 6, wherein the means for determining when the sample fluid (12) flows into the second fluidic compartment (11) comprises an electrode (22) in electrical connection with the at least one micromechanical actuator element (14).

8. A microfluidic device according to claim 1, wherein the microfluidic device furthermore comprises a non-wetting area (21) in between the first fluidic compartment and the second fluidic compartment.

9. A method for manufacturing a microfluidic device, the method comprising:
providing a first fluidic compartment (10),
providing a second fluidic compartment (11), and
providing at least one micromechanical actuator element (14) for, when in use, allowing a sample fluid (12) to flow from the first fluidic compartment (10) into the second fluidic compartment (11), actuation of the micromechanical actuator element causing:
a distortion or breaking, of the fluid meniscus, and/or
lowering of the surface tension, e.g. by creating a hydrophobic/hydrophilic path across the barrier, and/or
creation of fluid displacement across the barrier by enforcing a flow.

10. Method for controlling flow of a sample fluid (12) from a first fluidic compartment (10) to a second fluid compartment (11) of a microfluidic device, the method comprising:
applying a sample fluid (12) to the first fluidic compartment (10), and actuating at least one micromechanical actuator element (14) for allowing the sample fluid (12) to flow from the first fluidic compartment (10) to the second fluid compartment (11), actuation of the micromechanical actuator element causing:
a distortion or breaking, of the fluid meniscus, and/or
lowering of the surface tension, e.g. by creating a hydrophobic/hydrophilic path across the barrier, and/or
creation of fluid displacement across the barrier by enforcing a flow.

11. Method according to claim 10, wherein actuating the at least one micromechanical actuator element (14) is performed electrically, optically, magnetically or by heating.

12. Method according to claim 10, furthermore comprising means for determining when the sample fluid (12) flows into the second fluidic compartment (11).

13. Method according to claim 12, wherein the means for determining when the sample fluid (12) flows into the second fluidic compartment (11) comprises an electrode (22) in electrical connection with the at least one micromechanical actuator element (14).

14. A controller (30) for controlling flow of a sample fluid (12) from a first fluidic compartment (10) to a second fluid compartment (11) of a microfluidic device, the controller comprising a control unit (31) for controlling actuation means (32) for actuating at least one micromechanical actuator element (14) of the microfluidic device, actuation of the micromechanical actuator element causing:
a distortion or breaking, of the fluid meniscus, and/or
lowering of the surface tension, e.g. by creating a hydrophobic/hydrophilic path across the barrier, and/or
creation of fluid displacement across the barrier by enforcing a flow.

15. A computer program product for performing, when executed on a computing means, a method as in claim 10.
